(19) United States
(12) Patent Application Publication
(10) Pub. No.: US 2006/0182898 A1
(43) Pub. Date: Aug. 17, 2006

(54) Batteryless display apparatus

(75) Inventors: Amir Ben-Shalom, Modiin (IL); David Coates, Dorset (GB)

Correspondence Address: FOLEY AND LARDNER LLP;SUITE 500, 3000 K STREET NW, WASHINGTON, DC, 20007, US

(73) Assignee: MAGINK DISPLAY TECHNOLOGIES, LTD.

(21) Appl. No.: 11/335,844

(22) Filed: Jan. 20, 2006

(30) Foreign Application Priority Data
Jan. 21, 2005 (GB) 0501341.2

(51) Int. Cl. G02F 1/1333; C09K 19/02

(52) U.S. Cl. 428/1.3; 428/1.1; 349/169; 349/176

(57) ABSTRACT

A display apparatus includes a cholesteric liquid crystal display device comprising a layer of cholesteric liquid crystal material contained between two substrates, each substrate carrying an electrode layer so that the layer of cholesteric liquid crystal material is interposed between the electrode layers. A piezoelectric element is electrically connected to the electrode layers of the cholesteric liquid crystal display device. The piezoelectric element is capable of being manually activated to generate a drive signal which is sufficient to switch the layer of cholesteric liquid crystal material from the planar state to the focal conic state. The substrates are arranged to allow the layer of cholesteric liquid crystal material to be sheared to switch the layer of cholesteric liquid crystal material from the focal conic state to the planar state by manual compression of the cholesteric liquid crystal display device. Thus the display device can be switched without the need for a battery or other power source.

### FIELD OF THE INVENTION

The present invention relates to display apparatuses, in particular to the provision of a display apparatus that can change the displayed image without the need for a battery or external power source.

### DESCRIPTION OF RELATED ART

All electronic display apparatuses require an electrical input to activate them for changing the displayed image. Typically, the power is supplied from a battery or an external power source such as mains electricity. There is high and increasing demand for portable display apparatuses.

Currently commercially available portable display apparatuses are powered by batteries. Even though techniques to reduce the power consumption are employed to increase the battery life, periodically the batteries must either be replaced or else recharged. This is inconvenient for the user and imposes design constraints, that is to allow battery replacement or to require the provision of a charging circuit which increase the cost and size. Typical batteries such as printed batteries produce an output voltage of 1.5V or 3V but for display devices employing common display technologies higher voltages are required. This means that step-up converters are employed which further decreases the battery life. Batteries also create environmental problems in their disposal.

Of course these problems with batteries may be avoided by using an external power source, but then the portability of the display apparatus is compromised as access to the power source is required.

Another type of power source sometimes used is a solar power source, but these typically produce low voltages, particularly indoors where the output voltage might be of the order of a few volts. Accordingly, solar power sources are difficult to use to drive display devices which for common display technologies require higher voltages.

To alleviate these problems, it would be desirable to provide a display apparatus that can change the displayed image without the need for a battery, a solar power source or an external power source.

### BRIEF SUMMARY OF THE INVENTION

According to the present invention, there is provided a display apparatus comprising:

a cholesteric liquid crystal display device comprising a layer of cholesteric liquid crystal material contained between two substrates, each substrate carrying an electrode layer so that the layer of cholesteric liquid crystal material is interposed between the electrode layers; and

an electro-active element electrically connected to the electrode layers of the cholesteric liquid crystal display device,

the electro-active element being capable of being manually activated to generate a drive signal sufficient to switch the layer of cholesteric liquid crystal material from the planar state to the focal conic state, and

the substrates being arranged to allow the layer of cholesteric liquid crystal material to be sheared to switch the layer of cholesteric liquid crystal material from the focal conic state to the planar state by manual compression of the cholesteric liquid crystal display device.

Thus, the present invention involves a combination of a cholesteric liquid crystal display device as a type of display device and an electro-active element as a type of power source. The possibility of combining these two elements is based on an appreciation that an electro-active element such as a piezoelectric element is capable of capable of being manually activated to generate a drive signal sufficient to switch the layer of cholesteric liquid crystal material from the planar state to the focal conic state. As the cholesteric liquid crystal material is reflective in the planar state and transmissive (or strictly speaking mildly scattering) in the focal conic state, this causes a change in the image displayed on the display device. The form of the image depends on the patterning of the electrode layers which may be freely chosen.

The electro-active element is capable of generating a drive signal of sufficient magnitude to switch the layer of cholesteric liquid crystal material from the planar state to the focal conic state. This is because of the size of the electromechanical response of a typical electro-active element capable of manual activation.

Furthermore, the electro-active element is capable of generating a drive signal which is AC in nature, because a positive pulse is generated as the electro-active element is initially manually activated and a negative pulse is generated as the electro-active element is subsequently released. This is advantageous because an AC drive signal reduces electrochemical degradation of the liquid crystal material. The change of the state of the liquid crystal material may be used to change the image displayed on the display device. Thus the electro-active element causes the change of the image without any need for a battery or external power source.

To switch the layer of cholesteric liquid crystal material from the focal conic state to the planar state, the electro-active element is not used because this change of state requires a higher drive voltage than the change from the planar state to the focal conic state and thus it is more difficult to arrange an electro-active element to provide the appropriate drive signal. Instead, the substrates are arranged to allow the layer of cholesteric liquid crystal material to be sheared to switch the layer of cholesteric liquid crystal material from the focal conic state to the planar state by manual compression of the cholesteric liquid crystal display device. In general terms, it is known that a layer of cholesteric liquid crystal material is capable of being sheared to switch the layer of cholesteric liquid crystal material from the focal conic state to the planar state by manual compression of the cholesteric liquid crystal display device. However this is normally an undesirable effect and so in practical display apparatuses the substrates are arranged to prevent manual compression of the layer of cholesteric liquid crystal material. In contrast in the present invention, the substrates are arranged to allow the user to use manual compression in order to change the image back from the focal conic state produced by the electro-active element. This requires no additional circuit elements and is straightforward for the user.

The present invention has numerous advantages.

Firstly, the display apparatus is fully portable whilst avoiding the problems with a battery or external power source which are discussed above.

Secondly, the use of a cholesteric liquid crystal display device provides particular advantages intrinsic to this type of display, in particular being a reflective display which provides an image with high brightness and good contrast. These advantages are very useful in the context of a portable apparatus which is often used in lighting conditions which are not ideal.

Thirdly, the display apparatus is easy to implement. The electro-active element may be one of many commonly available types, for example a simple piezoelectric buzzer or a piezoelectric bender. Furthermore, the electro-active element, as a result of being able to produce an appropriate drive signal, may be connected to the cholesteric display apparatus in a straightforward manner without any circuitry to modify the form of the signal output of manual activation, such as a step-up converter or the like.

As mentioned above, the electro-active element may take a wide range of forms. Preferably, the electro-active element is a piezoelectric element, for example a block of piezoelectric material activatable by compression or a piezoelectric element having a bender construction and being activatable by bending. However, it is possible to use other types of electro-active element which generate an electrical signal on activation, for example an electrostrictive element.

### BRIEF DESCRIPTION OF THE DRAWINGS

In the drawings:

FIG. 1 is a cross-sectional view of a cholesteric liquid crystal display device;

FIG. 2 is a view of a first display apparatus which employs a single piezoelectric element;

FIG. 3 is a cross-sectional view of the piezoelectric element in the first display apparatus of FIG. 2;

FIG. 4 is a graph of the signal output by a piezoelectric element on manual activation;

FIG. 5 is a state diagram illustrating scheme for operation of the display apparatus of FIG. 2;

FIG. 6 is a view of a second display apparatus in three different display states;

FIG. 7 is a circuit diagram of the second display apparatus of FIG. 6; and

FIG. 8 is a perspective view of a third display apparatus.

### DETAILED DESCRIPTION OF THE INVENTION

Embodiments of the present invention will now be described by way of non-limitative example with reference to the accompanying drawings.

Several display apparatuses will be described below. Each one includes a cholesteric liquid crystal display device 10 as shown in FIG. 1 and which will now be described.

The display device 10 has a layered construction, the thickness of the individual layers 11-19 being exaggerated in FIG. 1 for clarity.

The display device 10 comprises two substrates 11 and 12, which may be made of glass or preferably plastic. The substrates 11 and 12 have, on their inner facing surfaces, respective transparent electrode layers 13 and 14 formed as a layer of transparent conductive material, typically indium tin oxide, so that the electrode layers 13 and 14 are carried by the respective substrates 11 and 12. The electrode layers 13 and 14 are patterned to allow the display device 10 to display an image, as described in more detail below.

Optionally, each electrode layers 13 and 14 is overcoated with a respective insulation layer 15 and 16, for example of silicon dioxide, or possibly plural insulation layers.

The substrates 11 and 12 define between them a cavity 20, typically having a thickness of 3 μm to 8 μm. The cavity 20 contains a liquid crystal layer 19 and is sealed by a glue seal 21 provided around the perimeter of the cavity 20. Thus the liquid crystal layer 19 is arranged between the electrode layers 13 and 14.

Each substrate 11 and 12 is further provided with a respective alignment layer 17 and 18 formed adjacent the liquid crystal layer 19, covering the respective electrode layer 13 and 14, or the insulation layer 15 and 16 if provided. The alignment layers 17 and 18 align and stabilise the liquid crystal layer 19 and are typically made of polyimide which may optionally be unidirectionally rubbed. Thus, the liquid crystal layer 19 is surface-stabilised, although it could alternatively be bulk-stabilised.

Alternatively, the electrode layers 13 and 14 could be arranged outside the substrates 11 and 12, and/or could be carried by the substrates 11 and 12 with other layers intermediate the electrode layers 13 and 14 and the substrates 11 and 12.

The display device 10 has a coloured layer 22 disposed to the rear (lowermost in FIG. 1) of the liquid crystal layer 19, in particular on the rear surface of the rear substrate 12. The coloured layer 22 may be formed as a layer of paint. In use, the coloured layer 22 absorbs any incident light which is not reflected by the display device 10. As an alternative, the coloured layer 22 and the rear electrode layer 14 could be replaced by a single layer performing both the functions of providing electrical contact and absorbing light and being for example a carbon base or a metal coated with black polyimide.

The operation of the display device 10 is as follows.

The liquid crystal layer 19 comprises cholesteric liquid crystal material. Such material has several states in which the reflectivity and transmissivity vary. These states include the planar state and the focal conic state, as described in I. Sage, Liquid Crystals Applications and Uses, Editor B Bahadur, vol 3, page 301, 1992, World Scientific, which is incorporated herein by reference and the teachings of which may be applied to the present invention. The planar state and the focal conic state are used in the present embodiment because they are stable states in the sense that they remain and can coexist in the absence of any applied drive signal. Cholesteric liquid crystal material also has a homeotropic (pseudo nematic) state but this state is not used in the present embodiment because it is unstable in the sense that maintenance of the homeotropic state requires continuous application of a drive signal.

In the planar state, the liquid crystal layer 19 selectively reflects a bandwidth of light that is incident upon it and so may be said to be reflective even though not all the incident light is reflected. Thus the planar state is used as the bright state of the display device 10. The wavelengths λ of the reflected light are given by Bragg's law, ie λ=nP, where wavelength λ of the reflected wavelength, n is the refractive index of the liquid crystal material seen by the light and P is the pitch length of the liquid crystal material. Thus in principle any colour can be reflected as a design choice by selection of the pitch length P. That being said, there are a number of further factors which determine the exact colour, as known to the skilled person. The colour of the light reflected in the planar state may be freely chosen but green is good for reasons of aesthetic qualities and the perceived brightness.

In the focal conic state, the liquid crystal layer 19 is, relative to the planar state, transmissive and transmits incident light. Thus the focal conic state is used as the dark state of the display device 10. Strictly speaking, the liquid crystal layer 19 is mildly light scattering with a small reflectance, typically of the order of 3-4%.

The light not reflected by the liquid crystal layer 19 is transmitted through the liquid crystal layer 19 and incident on the coloured layer 22. The coloured layer 22 is usually black so that it absorbs all the light incident on it. In this case, when the liquid crystal layer 19 is in the focal conic state the display device is perceived as black and when the liquid crystal layer 19 is in the planar state the display device is perceived as being of the colour of the light reflected by the liquid crystal layer 19. A black coloured layer 22 is preferred to maximise the contrast ratio (the ratio of the light reflected in the bright state to the dark state). For a black coloured layer 22, the inherent contrast ratio of an area of the liquid crystal layer 19 is typically of the order of 10:1. However, the coloured layer may be a different colour from black in which case it reflects some of the incident light. This modifies the colours perceived by the viewer when the display device 10 is in both the bright and dark states.

As described above, the display device 10 has a single liquid crystal layer 19. As an alternative, the display device 10 employ plural liquid crystal layers each reflecting a different colour in the bright state, for example by repeating the layers 11-19 shown in FIG. 1. This would enable the display device 10 to display a larger number of colours. However, such an increase in the number of liquid crystal layers would increase the cost and is not necessary for the basic function of the display device 10.

In operation, the liquid crystal layer 19 is switched between the two states to change the reflectance of the liquid crystal layer 19 and thereby to change the image displayed on the display device 10. The effect of changing the states of the liquid crystal layer 19 is described in W. Gruebel, U. Wolff and H. Kreuger, Molecular Crystals Liquid Crystals, 24, 103, 1973, the teachings of which may be applied to the present invention.

In commercially available display apparatuses including a cholesteric liquid crystal display device, switching between the planar and the focal conic states is effected by applying drive signals in the form of pulses across the liquid crystal layer, the drive signals being derived from an electrical power source such as a battery or an external power source. However, the display apparatus of the present invention effect switching without any such electrical power source, in particular by using a piezoelectrical element as will now be described.

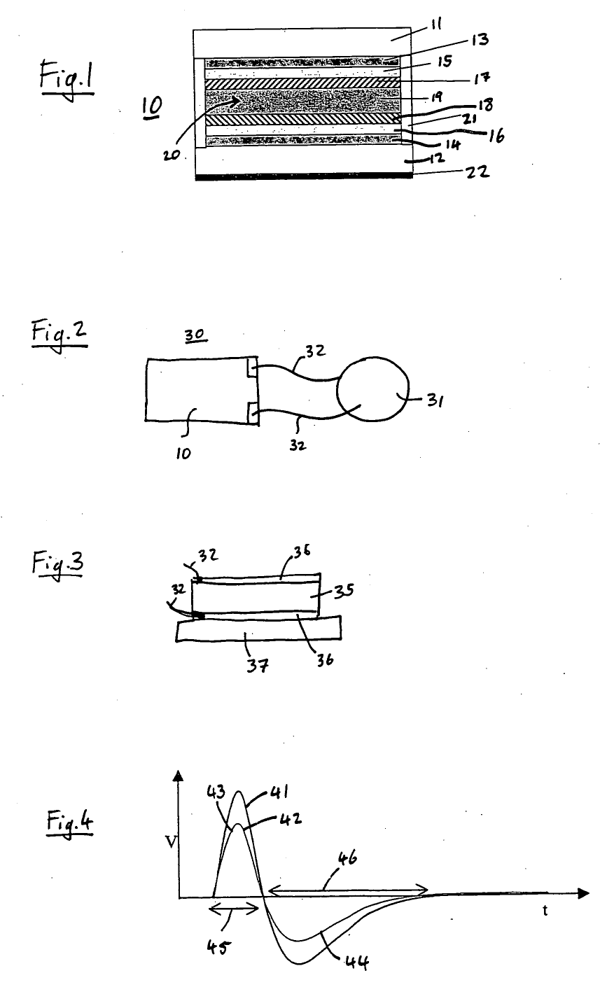

FIG. 2 illustrates a first display apparatus comprising the display device 10 electrically connected to a piezoelectric element 31 by conductive paths 32.

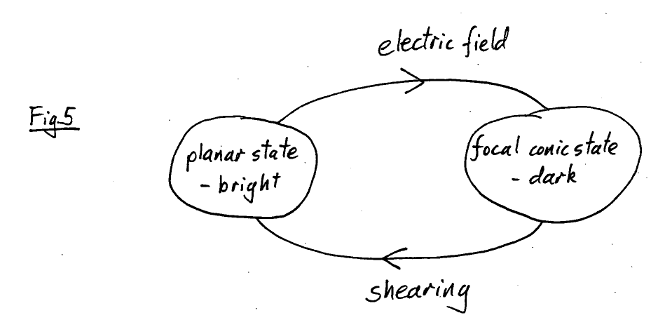

The piezoelectric element 31 is shown in FIG. 3 and comprises a block 35 of piezoelectric material arranged between two electrodes 36. The block 35 of piezoelectric material is activatable by compression. In this mode of activation, compression of the block 35 of piezoelectric material generates a signal across the two electrodes 36. As described in more detail below, the signal thus generated is capable of switching the layer of liquid crystal material 19 in the display device 10 from the planar state to the focal conic state. Thus, each of the conductive paths 32 is electrically connected between one of the electrodes 36 of the piezoelectric element 31 and one of the electrode layers 13 and 14 of the display device 10.

The block 35 of piezoelectric material and the electrode 36 are all mounted on a support 37. Thus, the piezoelectric element 31 takes the form of a simple disk bender of the type which is widely commercially available. For example, the piezoelectric element 31 may be a disk bender supplied by a PC International, Ltd., for example catalogue no. 2-352611 (FT-35T-2.8A1) or as supplied by HDK, for example under the catalogue no. HAS-RW2-30-20-1. This type of piezoelectric element is commonly used as a buzzer by electrically activating the block 35 of piezoelectric material by applying an alternating signal across the electrodes 36 which causes the block 35 of piezoelectric material to alternatively expand and contract. The stress between the block 35 of piezoelectric material and the support 37 causes the entire piezoelectric element 31 to bend perpendicular to the interface therebetween, thereby generating sound. In contrast, the piezoelectric element 31 is used in the display apparatus 30 in a much simpler mode of operation involving merely manual compression of the block 35 of piezoelectric material.

As an alternative, the support 37 may be made of a conductive material such as metal so that is acts as an electrode and replaces the electrode 36 between the block 35 of piezoelectric material and the support 37.

On manual compression of the piezoelectric device 31, the electrical signal produced across the electrodes 36 is of the form illustrated in FIG. 4 which shows a waveform 41 in the absence of a load and a waveform 42 with a capacitive load of 10 nF which is a typical value for the display device 10 if it has an area of a few cm². The waveform 42 is AC in nature in that it consists of two pulses of opposite polarity, namely a positive pulse 43 followed by a negative pulse 44.

The positive pulse 43 is generated on initial manual compression of the piezoelectric element 31. This may be achieved by using a finger to press on the piezoelectric element 31 whilst it is resting on a surface or may be achieved by compressing the piezoelectric element 31 between a finger and a thumb. The negative pulse 44 occurs when the piezoelectric element 31 is subsequently released. The length of the positive pulse 43 as shown by the arrow 45 is typically of the order of 50-300 ms depending on the speed with which the piezoelectric element 31 is pressed. The length of the negative pulse 44 as shown by the arrow 46 is dependent on the natural relaxation of the piezoelectric element 31 and is typically longer than the positive pulse 43 and of the order of 1000 ms.

It has been appreciated that the type of electrical waveform generated by manual compression of the piezoelectric element 31 is capable of switching the layer of liquid crystal material 19 in the display device 10 from the planar state to the focal conic state. Such switching of the state of the layer of liquid crystal material 19 requires a pulse of the order of 10-30V, depending on the thickness of the layer of liquid crystal material 19. A pulse of such magnitude is easily achievable by the piezoelectric element 31. To illustrate this, measurements were taken of the electrical waveform generated on manual compression of the two specific piezoelectric buzzers identified above. The buzzer supplied by HDK under the catalogue no HAS-RW2-30-20-1 produced a positive pulse 43 when connected to a typical capacitive load of 10 mF of magnitude around 42-46V and a negative pulse 44 of magnitude around 22-26V. The buzzer supplied by a PC International, Ltd., for example catalogue no. 2-352611 (FT-35T-2.8A1) produced a positive pulse 43 when connected to a typical capacitive load of 10 mF of magnitude around 20-40V and a negative pulse 44 of slightly lower voltage. The actual voltage depends on how hard the piezoelectric element is pressed but these voltages can easily be produced manually. Thus it can be seen that the signal output by the piezoelectric element 31 is sufficient to switch the layer of liquid crystal material 19 from the planar state to the focal conic state.

The positive pulse 43 and the negative pulse 44 have different magnitudes but can be considered as balanced in the sense that the powers of the positive pulse 43 and the negative pulse 44 are approximately equal. Thus, the waveform output by the piezoelectric element 31 is particularly suitable as a drive signal for switching the layer of liquid crystal material 19, because its balanced AC nature is suitable for limiting or preventing electrochemical degradation of the liquid crystal material.

The form of the piezoelectric element 31 as a simple block 35 of piezoelectric material is preferred for simplicity and commercial availability. However, many other forms of piezoelectric elements are capable of producing a similar drive signal which is capable of switching the liquid crystal layer 19 from the planar state to the focal conic state. Accordingly, the piezoelectric element 31 may be replaced by other types of piezoelectric element. One possible alternative is a piezoelectric element which has a bender construction and which is manually activatable by bending. An example of a suitable piezoelectric element having a bender construction is shown in the third display apparatus of FIG. 8 below.

The precise construction of piezoelectric element 31 depends on the size and configuration of the display device 10. One factor is the drive signal required to effect switching of the liquid crystal layer 19 which itself depends on a number of factors such as the thickness of the liquid crystal 19, the dielectric anisotropy of the liquid crystal and temperature. Another factor is the area of the display device 10 driven by the piezoelectric element 13 which affects the loading on the piezoelectric element 31 and hence the voltage which is output. This effect is shown in FIG. 4 when the waveform 42 of the loading piezoelectric element 31 is produced in magnitude as compared to the waveform 41 of the piezoelectric element 31 with no load. However, in FIG. 4 the gap between the waveforms 41 and 42 is exaggerated in for clarity and in fact the waveform 42 with a capacitive load of 10 nF typically has a reduced magnitude of only around 3-4V as compared to the waveform 41.

Thus, although there is some variation depending on the configuration of the display device 10, in practice it is straightforward to select a piezoelectric element 31 which is capable of switching the liquid crystal layer 19 from the planar state to the focal conic state by simple testing of the display device 10 and candidates to form the piezoelectric element 31.

The way to switch the liquid crystal layer 19 back from the focal conic state to the planar state is by manual compression of the display device 10. This causes compression of the liquid crystal layer 19, thereby causing shearing of the material of the liquid crystal layer which causes the switching from the focal conic state to the planar state, this effect being known in itself. Thus, this switching may be achieved without requiring any components except the display device 10 itself, in particular without requiring any electrical power source such as a battery or an external power source.

Accordingly, the first display device 30 may be switched between the planar state and the focal conic state as shown in the state diagram of FIG. 5. The switching from the planar state to the focal conic state is achieved by an electric field generated by the piezoelectric element 31, whereas the switching from the focal conic state to the planar state is achieved by mechanical shearing of the liquid crystal layer 19 achieved my manual compression of the device display 10.

In particular, it is not necessary to use a piezoelectric element to switch the liquid crystal layer 19 back from the focal conic state to the planar state. This produces a number of advantages. Switching from the focal conic state to the planar state would require a piezoelectric element to generate a higher voltage than is necessary for the piezoelectric element 31 to switch the liquid crystal layer 19 from the planar state to the focal conic state. By way of comparison for a typical display device 10, switching from the planar state to the focal conic state might require a drive signal having pulses of magnitude 10V to 30V, whereas switching from the focal conic state to the planar state might typically require a drive voltage having pulses of magnitude 30V to 50V. This would require the use of a piezoelectric element of higher performance to produce the appropriate drive signal on manual compression. Also, the speed of switching from the focal conic state to the planar state is reduced as compared to the use of shearing. For these reasons, the use of shear to effect switching from the focal conic state to the planar state is preferred.

In general terms, the display device 10 has a similar construction to the type of cholesteric liquid crystal display device used in a number of commercial products in which the liquid crystal layer 19 is driven by a drive signal derived from an electrical power source. However, in typical commercial products shearing of the liquid crystal display be compression is undesirable. Thus there are a number of design considerations which may be applied to the display device 10 to improve the operation in the first display apparatus 30, in particular to allow the liquid crystal layer 19 to be sheared by manual compression of the display device 10.

Firstly, it is possible to control the thickness of the substrates 11 and 12 and to control the provision of spacers in the liquid crystal layer 19 in order to improve the ease with which the liquid crystal layer 19 may be switched from the focal conic state to the planar state by manual compression of the display device 10.

As regards the substrates 11 and 12, these can be designed with increased flexibility in order to assist in the transfer of force applied by manual compression to the outside of the display device 10 to the liquid crystal layer 19 to effect shearing. This may be achieved in a number of ways.

Firstly, given that the front substrate 11 is more likely to be exposed to allow viewing of the image on the display device 19, the front substrate 11 may be made more flexible than the rear substrate 12, for example by making the front substrate thinner than the rear substrate 12 if they are both made of the same material.

Secondly, the thickness of the front substrate 11 may be controlled to reduce its flexibility. For example, in the case that the front substrate 11 is made from glass it should preferably have a thickness of at most 1 mm, more preferably at most 0.7 mm. In general to maintain structural integrity, the front substrate 11 if made of glass will have a thickness of at least 0.5 mm.

Thirdly, the front substrate 11 may be made of plastic to provide good flexibility. A suitable plastic is PET (polyethylene terephthalate) which may be engineered PET incorporating barrier layers such as water and oxygen blocking layers. In the case that the front substrate 11 is made of plastic, it preferably has a thickness of at most 200 μm, more preferably at most 100 μm.

As regards the provision of spacers, it is noted that a cholesteric liquid crystal display device typically includes spacers in the liquid crystal layer 19 at a density of around 150 mm⁻². The purpose of such spacers is to maintain the separation of the substrates 11 and 12 and hence the thickness of the liquid crystal layer 19. However, the spacers tend to resist compression of the liquid crystal layer 19. Accordingly, in the first display apparatus 30, the number of spacers in the liquid crystal layer 19 may be reduced to assist the shearing of the liquid crystal layer 19 to effect switching from the focal conic state to the planar state on manual compression of the display device 10. Preferably the density of the spacers is at most 100 mm⁻², more preferably at most 50 mm⁻². The ideal density of spacers depend on the flexibility of the substrates 11 and 12, in particular the front substrate 11.

The nature of the liquid crystal material of the liquid crystal layer 19 may be selected to improve the switching in response to the drive signal output by the piezoelectric element 31. To reduce the voltage needed, it is possible to use liquid crystal material of increased dielectric anisotropy. Preferably, the liquid crystal material of the liquid crystal layer 19 has a dielectric anisotropy in the range from 12 to 30.

The separation of the substrates 11 and 12 and hence the thickness of the liquid crystal layer 19 may also be adjusted. In particular, to reduce the voltage of the drive signal required to effect switching from the planar state to the focal conic state, it is possible to decrease the thickness of the liquid crystal layer 19. However, such reduction in the thickness of the liquid crystal layer 19 also reduces the reflectance of the liquid crystal layer 19 in the planar state. Thus, in selecting in thickness of the liquid crystal layer 19, there is a trade-off between the brightness of the display device 10 and the voltage required for switching. To give maximum brightness, ideally the thickness of the liquid crystal layer 19 is sufficient to provide more than ten helical terms in the structure of the liquid crystal material, this equating to a thickness of around 3 μm for blue light, around 3.5 cm for green light and around 4 μm red light.

Thus, both the anisotropy of the liquid crystal material and the thickness of the liquid crystal layer 19 may be adjusted to optimise performance, but in practice it is possible to select a wide range of values which allow operation by the piezoelectric elements 31. For example, it has been found that liquid crystal layers 19 with thicknesses over the range of at least 4 μm to 6 μm with liquid crystal material having a dielectric anisotropy of 15 can readily be switched from the planar state to the focal conic state by the piezoelectric element 31.

As an example, the first display apparatus 30 was manufactured with a display device 10 having substrates 11 and 12 made of glass with a thickness of 11 mm and having a liquid crystal layer 19 with a thickness of 5 μm and having spacers at a density of 120 mm⁻². The electrode layers 13 and 14 were formed from 15Ω indium tin oxide and each patterned as a single electrode extending over the entire area of the display device 10, that area being about 4 cm². Non-rubbed alignment layers 17 and 18 were formed with a thickness of 40 nm from SE130 (commercially available from Nissan Chemicals). The coloured layer 22 was matt black paint applied by spray-coating. The liquid crystal material was selected to have a reflection peak at 550 mm, a dielectric anisotropy of 15 and a birefringence of 0.21. The piezoelectric element 31 was a piezoelectric disk bender commercially available from APC International, Ltd. under the catalogue no. 2-352611 (FT-35T-2.8A1). The display device 10 was manually compressed. This placed the liquid crystal layer 19 in the planar state and thus the display device 10 appeared bright green. Subsequently, the piezoelectric element 31 was compressed manually, simply by pressing the piezoelectric element 31 and releasing it. This caused switching of the liquid crystal layer 19 to the focal conic state so that the display device 10 appeared black.

As mentioned above, the form of the image displayed on the display device 10 depends on the patterning of the electrode layers 13 and 14. The electrode layers 13 and 14 may be patterned in a number of ways to show different images and achieve different effects.

One possibility is for each of the electrode layers 13 and 14 to constitute a single electrode over the entire area of the display device 10. In this case, the entire display device 10 is switched from the planar state to the focal conic state, that is the bright state to the dark state, on manual activation of the piezoelectric element 31. This mode of operation is preferred when the display apparatus 10 is to be used as a drawing tablet by application of pressure to a portion of the display device by a finger or a suitable implement which causes switching from the focal conic state to the planar state, that is the dark state to the bright state, on those areas to which pressure is applied.

Another possibility is for the electrode layers 13 and 14 to be patterned to provide a plurality of independently operable segments over the area of the display device 10. This is typically achieved by one of the electrode layers 13 and 14 being patterned as a plurality of separate electrodes which are driven independently and the other of the electrode layers 13 and 14 being formed as a single common electrode over the entire area of the display device 10. In this case, control of the separate electrodes causes selective switching of the adjacent area of the liquid crystal layer 19 which thereby constitutes one of the independently operable segments. The independently operable segments may have different shapes to allow the display of different images as is conventional in many types of liquid crystal display device. For example, the plurality of segments may have an alphanumeric display configuration to allow a selective display of different alphanumeric characters depending on which segments are selected. Similarly, the plurality of segments may be arranged in an array to provide an array of pixels which may be selectively operated to form an image.

A display apparatus in accordance with the present invention have numerous advantages. The use of a cholesteric liquid crystal display device 10 provides the advantages intrinsic to this type of display device, in particular providing an image with high brightness and good contrast. This is achieved whilst allowing the display device to be portable without the need for a battery or external power source with the associated disadvantages discussed above. As such, display apparatuses in accordance with the present invention has a number of uses.

In principle, the first display apparatus 10 may be provided in the form shown in FIG. 2 with the conductive paths 32 formed by wires and without providing any further components. However, in practice the first display apparatus 10 will be provided in an appropriate package to house the display device 10 and the piezoelectric element 31. For example, when the display apparatus 10 is used as a drawing tablet, the display device 10 and the piezoelectric element 31 might be packaged in a plastic casing for protection.

Another possible use is in a decorative tile to be applied to a wall or other surface. In this case, the display device 10 forms the visible surface of a tile and the piezoelectric element 31 is disposed in the same tile or a different tile to be compressed, for example by kicking, to erase the pattern on the tiles.

Another possible use is as a labelling device.

Another possible use is as a force or pressure indicator. In many mechanical and construction installations one has to use some specific force or pressure in the process, for example in a torque wrench. The incorporation of a display apparatus in accordance with the present invention can provide a visual image of the force being applied.

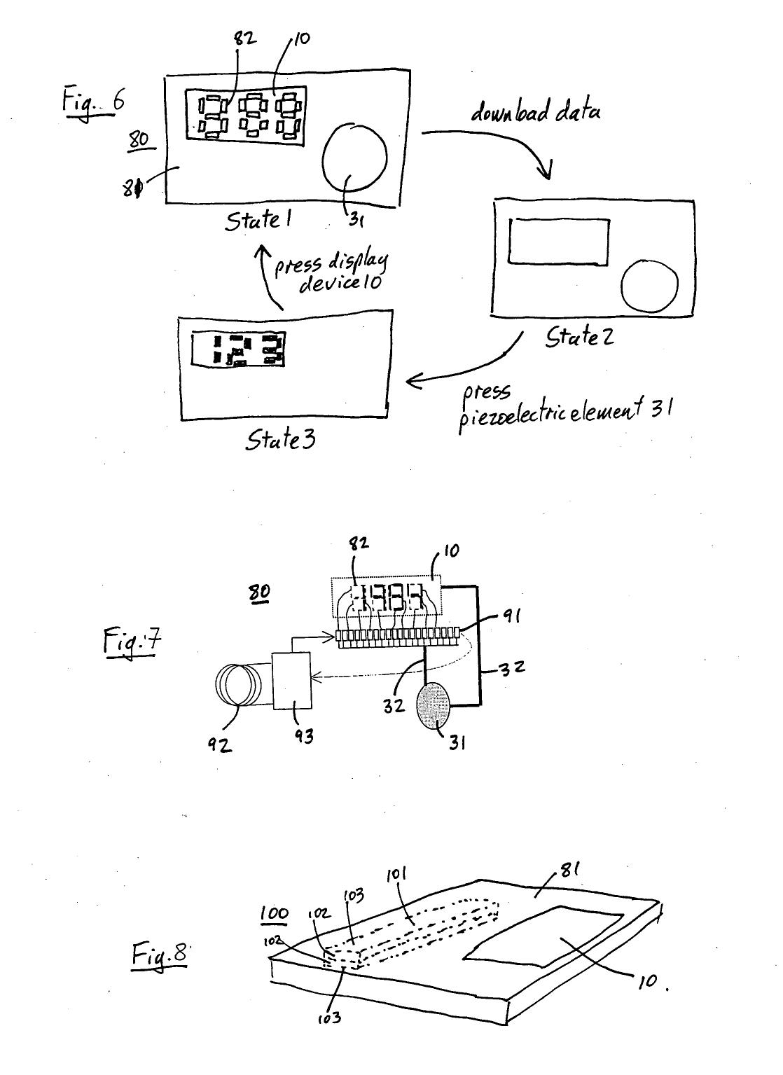

Another use is for display apparatuses in accordance with the present invention to be incorporated into a card such as a credit card. As an example of this second display apparatus 80 shown in FIG. 6 will now be described.

The second display apparatus 80 has the same construction as the first display apparatus 30 of FIG. 3 but with some modifications which are described below. For clarity, in respect of common elements, the same reference numerals will be used and a description thereof will not be repeated.

The second display apparatus 80 is incorporated into a card 81 which has a laminated construction of the type of a conventional credit card. Thus, the card 81 may be manufactured using the same techniques as applied to such conventional credit cards. The second display apparatus 80 is arranged with the display device 10 and the piezoelectric elements 31 exposed in the top surface of the card 81. The card 81 may have other conventional components to operate as a credit card, for example a magnetic strip, a microchip with appropriate contacts and one or more security devices such as a hologram.

In the display device 10, one of the electrode layers 13 and 14 is patterned to provide an array of electrodes 82 shown schematically in FIG. 6 which provide the display device 80 with a plurality of independently operable segments in the regions adjacent respective electrodes 82. The segments may be arranged in an alphanumeric display configuration as shown in FIG. 6 comprising plural groups of seven segments in a figure-of-eight arrangement so that selective operation of the segments in each group allows display of different alphanumeric characters.

The circuit of the display apparatus 80 is shown in FIG. 7 and includes an array of bi-directional analogue switches 91 interposed in one of the conductive paths 32 between the piezoelectric element 31 and the one of the conductive layers 13 and 14 of the display device 10 which is patterned to provide the array of electrodes 82. In particular, the piezoelectric element 31 is connected to each of the electrodes 82 through a respective one of the analogue switches 91 so that the state of the analogue switches 91 controls the application of a drive signal from the piezoelectric element 31 to the respective segments of the display device 10 when the piezoelectric element 31 is manually activated.

To address the analogue switches 91, the display apparatus 80 is provided with a control circuit in the form of a passive radio frequency transponder comprising a radio frequency antenna 92 and a decoder circuit 93 which may be constructed using known radio frequency identification (RFID) technology. Such a control circuit may be operated without any electrical power source by using the power of the received radio frequency signal received by the antenna 92. An external transmitter (not shown) supplies a radio frequency signal including data identifying which segments of the display device 10 are and are not to be turned on to display characters on the display device 10. The radio frequency signal is received by the antenna 92 and supplied to the decoder circuit 93. The decoder circuit 93 demodulates the radio frequency signal and in response thereto controls the state of the respective analogue switches 91 identified by the data in the radio frequency signal. This has the effect of controlling which segments of the display device 10 receives the drive signal from the piezoelectric element 31 on manual activation thereof, and hence the image displayed on the display device 10.

The second display apparatus 80 is operated as shown in FIG. 6. Normally the display device 10 is in State 1 in which the liquid crystal layer 19 is in the planar state over its entire area so that the entire display device 10 is in the bright state.

The user brings the display apparatus 80 to the vicinity of an external transmitter, which may be for example in a terminal such as a cashpoint or a till in a shop. The external transmitter transmits a radio frequency signal to display an image on the display device 10, for example representing available credit or other financial information. The radio frequency signal is received by the antenna 92 and used by the decoder circuit 93 to control the analogue switches 91. This causes the display apparatus 80 to go into State 2 shown in FIG. 6 in which the data from the external transmitter is stored by the analogue switches 91 which thereby effectively act as a non-volatile memory storing that data without any change to the image displayed on the display device 10.

Subsequently, when the user wishes to display the information transmitted from the external transmitter, the user presses the piezoelectric element 31 to manually activate it. This generates a drive signal which is capable of switching the liquid crystal layer 19 of the display device 10 from the planar to the focal conic state. The state of the analogue switches 91 controls whether this drive signal is supplied to respective segments. Accordingly, the display apparatus 80 is transferred to State 3 in which the display device 10 displays an image of the characters represented by the data transmitted from the external transmitter. This allows the user to view this information.

The user may then erase the image from the display device 10 by pressing the display device 10 to switch the liquid crystal layer 19 from the focal conic state to the planar state. This returns the display apparatus 80 into State 1. The display apparatus 80 may be cycled around States 1 to 3 indefinitely.

The display apparatus 80 is advantageous, because it allows information to be transmitted to the display apparatus 80 and to be viewed at a later point in time by the user. This is of particular advantage where the information is of a sensitive nature, for example providing financial information.

A third display apparatus 100 is shown in FIG. 8. The third display apparatus 100 is identical to the second display apparatus 80 except that the piezoelectric element 31 is replaced by a piezoelectric element 101 having a bimorph bender construction. In particular, the piezoelectric element 101 is a layered construction comprising two layers 102 of piezoelectric material poled in opposite directions and arranged between a pair of electrodes 103. Accordingly, the piezoelectric element 101 is mechanically activated by bending perpendicular to the plane of the layers 102 of piezoelectric material. As conventional for a piezoelectric element having a bender construction, this generates an electrical signal on the electrodes 103 because bending of the piezoelectric element 101 causes the layers 102 to undergo a differential change of length, for example one layer 102 expanding with the other layer 102 contracting. The piezoelectric element 101 is embedded in the card 81 with the plane of the layers 102 parallel to the plane of the card 81 so that flexing of the card 81 causes bending and mechanical activation of the piezoelectric element 101.

1. A display apparatus comprising:
a cholesteric liquid crystal display device comprising a layer of cholesteric liquid crystal material contained between two substrates, each substrate carrying an electrode layer so that the layer of cholesteric liquid crystal material is interposed between the electrode layers; and
an electro-active element electrically connected to the electrode layers of the cholesteric liquid crystal display device,
the electro-active element being capable of being manually activated to generate a drive signal sufficient to switch the layer of cholesteric liquid crystal material from the planar state to the focal conic state, and
the substrates being arranged to allow the layer of cholesteric liquid crystal material to be sheared to switch the layer of cholesteric liquid crystal material from the focal conic state to the planar state by manual compression of the cholesteric liquid crystal display device.

2. A display apparatus according to claim 1, wherein the cholesteric display device has a front side from which the layer of cholesteric liquid crystal material is visible, the substrate on the front side of the cholesteric display device being more flexible than the substrate on the rear side of the cholesteric display device.

3. A display apparatus according to claim 1, wherein the cholesteric display device has a front side from which the layer of cholesteric liquid crystal material is visible, the substrate on the front side of the cholesteric display device being made of glass having a thickness of at most 1 mm.

4. A display apparatus according to claim 3, wherein the substrate on the front side of the cholesteric display device being made of glass having a thickness of at most 0.7 mm.

5. A display apparatus according to claim 3, wherein the substrate on the front side of the cholesteric display device being made of glass having a thickness of at least 0.5 mm.

6. A display apparatus according to claim 1, wherein the cholesteric display device has a front side from which the layer of cholesteric liquid crystal material is visible, the substrate on the front side of the cholesteric display device being made of plastic having a thickness of at most 200 μm.

7. A display apparatus according to claim 6, wherein the substrate on the front side of the cholesteric display device is made of plastic having a thickness of at most 100 μm.

8. A display apparatus according to claim 6, wherein the plastic is polyethylene terephthalate.

9. A display apparatus according to claim 1, wherein the layer of cholesteric liquid crystal material contains spacers at a density of at most 100 mm⁻².

10. A display apparatus according to claim 1, wherein the layer of cholesteric liquid crystal material contains spacers at a density of at most 50 mm⁻².

11. A display apparatus according to claim 1, wherein the layer of cholesteric liquid crystal material has a dielectric anisotropy in the range from 12 to 30.

12. A display apparatus according to claim 1, wherein the electro-active element is a piezoelectric element.

13. A display apparatus according to claim 12, wherein the piezoelectric element comprises a block of piezoelectric material activatable by compression.

14. A display apparatus according to claim 12, wherein the piezoelectric element has a bender construction and is activatable by bending.

15. A display apparatus according to claim 1, wherein
the electrode layers are patterned to provide a plurality of independently operable segments, and
the display apparatus further comprises:
a plurality of analog switches, the electro-active element being electrically connected to each of the segments through a respective analog switch; and
a control circuit capable of switching the state of the respective analog switches in response to an externally supplied signal.

16. A display apparatus according to claim 15, wherein the control circuit is a passive radio frequency identification transponder.

17. A display apparatus according to claim 16, wherein the passive radio frequency identification tag comprises a radio frequency antenna and a decoder circuit arranged to decode a radio frequency signal received by the radio frequency antenna as said externally supplied signal, the decoder circuit and the plurality of analog switches being provided in a microchip.

18. A display apparatus according to claim 17, wherein the plurality of segments have an alphanumeric display configuration.

19. A display apparatus according to claim 1, wherein the cholesteric display device has a coloured background layer behind the layer of cholesteric liquid crystal material.
